(19) United States
(12) Patent Application Publication
(10) Pub. No.: US 2015/0055927 A1
(43) Pub. Date: Feb. 26, 2015

(54) FIBER ASSEMBLY WITH TRAY FEATURE

(71) Applicant: CORNING OPTICAL COMMUNICATIONS LLC, Hickory, NC (US)

(72) Inventor: Sherrh Clint Reinhardt, Hickory, NC (US)

(21) Appl. No.: 14/529,705

(22) Filed: Oct. 31, 2014

Related U.S. Application Data
(63) Continuation of application No. 13/096,358, filed on Apr. 28, 2011.

(51) Int. Cl. G02B 6/36

(52) U.S. Cl. CPC G02B 6/368
USPC 385/135

(57) ABSTRACT

A fiber assembly includes a fiber supporting matrix that comprises a length and a width, wherein the fiber supporting matrix comprises a first number of fiber positions that are assembled in a linear configuration across the width and extend along the length from a first end to a second end of the fiber supporting matrix. A second number of secured non-transmitting fibers are secured in a portion of the first number of fiber positions, wherein the second number of secured non-transmitting fibers terminate approximately at the second end of the fiber supporting matrix. A tray region on the fiber supporting matrix is defined by a plurality of adjacent empty fiber positions that do not secure the second number of secured non-transmitting fibers, wherein the tray region receives a third number of installed active fibers that correspond to the plurality of adjacent empty fiber positions.

### PRIORITY APPLICATION

This is a continuation of U.S. patent application Ser. No. 13/096,358, filed on Apr. 28, 2011, the content of which is relied upon and incorporated herein by reference in its entirety, and the benefit of priority under 35 U.S.C. §120 is hereby claimed.

### FIELD

The present disclosure generally relates to a fiber assembly with a tray feature and, more specifically, to embodiments of ribbon fiber that are configured for receiving a first number of fibers for input into a component that with a second number of fiber inputs.

### TECHNICAL BACKGROUND

Many current connectors include a predetermined number of optical fiber inputs such as optical fiber bores or the like. The connector may act as a ferrule for optical fiber and the optical fiber inputs may be arranged such that only properly aligned fibers will cause a connection with adequate data transmission quality. As an example, a multi-fiber connector such as a mechanical transfer (MT) connector may be configured with optical fiber inputs that are aligned in a linear fashion with a precise and tightly-spaced geometry. However, in many situations the number of input optical fibers is less than the number of optical fiber inputs on the connector. As a result, it may be difficult to properly align the input optical fibers with the input optical fiber ports on the connector.

### SUMMARY

Embodiments disclosed herein include fiber assemblies having a tray feature. One embodiment of a fiber assembly includes a fiber supporting matrix that comprises a fiber supporting side. The fiber supporting matrix has a length and a width, and the fiber supporting side comprises a first number of fiber positions that are assembled in a configuration across the width and extend along the length from a first end to a second end of the fiber supporting matrix.

The fiber assembly also includes a second number of secured non-transmitting fibers that are secured in a second number of corresponding fiber positions. The second number of secured non-transmitting fibers terminate approximately at the first end of the fiber supporting matrix. A tray region on the fiber supporting matrix is defined by a corresponding number of empty fiber positions that do not secure the second number of secured non-transmitting fibers. A third number of installed active fibers are installed into the empty fiber positions, wherein the third number of installed active fibers extend beyond the first end and the second end of the fiber supporting matrix.

Another embodiment of a fiber assembly includes a fiber supporting matrix that comprises a length and a width, wherein the fiber supporting matrix comprises a first number of fiber positions that are assembled in a linear configuration across the width and extend along the length from a first end to a second end of the fiber supporting matrix. The fiber assembly also includes a second number of secured non-transmitting fibers that are secured in a portion of the first number of fiber positions, wherein the second number of secured non-transmitting fibers terminate approximately at the second end of the fiber supporting matrix. A tray region on the fiber supporting matrix is defined by a plurality of adjacent empty fiber positions that do not secure the second number of secured non-transmitting fibers, wherein the tray region receives a third number of installed active fibers that correspond to the plurality of adjacent empty fiber positions.

Yet another embodiment of a fiber assembly includes a fiber supporting matrix that comprises a fiber supporting side, wherein the fiber supporting side comprises a first number of fiber positions that extend across a width of the fiber supporting matrix and extend along a length of the fiber supporting matrix from a first end to a second end of the fiber supporting matrix. The fiber assembly also includes a second number of secured non-transmitting fibers that are secured in a corresponding number of fiber positions, wherein the second number of secured non-transmitting fibers are not secured to a source and terminate approximately at the second end of the fiber supporting matrix. A tray region on the fiber supporting matrix is defined by empty fiber positions that do not secure the second number of secured non-transmitting fibers, wherein the tray region receives a third number of installed active fibers from a source that transmits a signal, wherein the third number of installed active fibers corresponds to the empty fiber positions.

Additional features and advantages will be set forth in the detailed description which follows, and in part will be readily apparent to those skilled in the art from that description or recognized by practicing the embodiments described herein, including the detailed description which follows, the claims, as well as the appended drawings.

### BRIEF DESCRIPTION OF THE DRAWINGS

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate various embodiments described herein, and together with the description serve to explain the principles and operations of the claimed subject matter.

FIG. 1 depicts a conventional optical fiber ribbon that includes twelve (12) optical fibers;

FIG. 2 depicts an optical connector having fiber inputs such as optical fiber bores;

FIGS. 3A-3C depict a fiber assembly having a tray region that is formed by four empty fiber positions within the fiber assembly;

FIGS. 4A-4B depict a fiber assembly with a tray region that is formed by two empty fiber positions within the fiber assembly;

FIGS. 5A-5D depict steps of making a fiber optic connector using a fiber assembly with a tray region, where the tray region holds a plurality of installed fibers that are inserted into the connector and intended for data transmission ;

FIG. 6 depicts a fiber assembly with a tray region holds a plurality of installed fibers, where the plurality of installed fibers are input into a connector;

FIG. 7 depicts a process flowchart for manufacturing a fiber assembly with a tray region; and

FIG. 8 depicts a process flowchart for manufacturing a ribbon fiber with a tray region and connector components.

### DETAILED DESCRIPTION

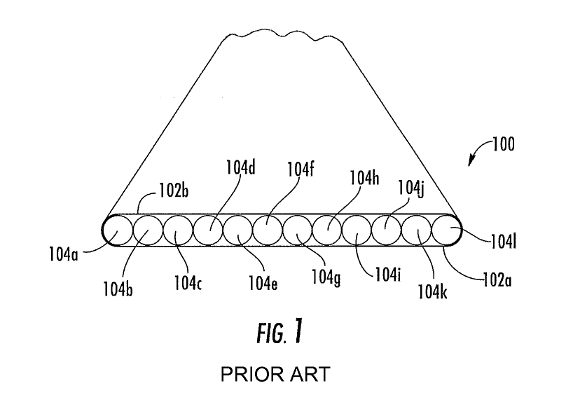

Referring initially to the drawings, FIG. 1 depicts a conventional optical fiber ribbon 100 that includes twelve (12) secured optical fibers 104, according to embodiments disclosed herein. As illustrated, the ribbon fiber has a matrix material with a first fiber supporting matrix side 102a and a second fiber supporting matrix side 102b. The first fiber supporting matrix side 102a and the second fiber supporting matrix side 102b may be shaped to accommodate and secure optical fibers 104a-104l with the matrix material. More specifically, in some embodiments, the fiber supporting matrices 102 are shaped with fiber positions and assembled in a linear configuration across from a first end of the fiber supporting matrices 102, across the width of the fiber supporting matrices 102 to a second end of the fiber supporting matrices 102. In other words, the fiber positions may extend the length of the optical fiber ribbon and may be sized to receive the secured optical fibers 104a-104l so the fibers maintain their organization and are not transposed within the matrix material. Additionally, while there are twelve (12) secured optical fibers 104a-104l on the fiber optic ribbon 100, this is merely an example, and any suitable number of optical fibers are possible so long as at least two optical fibers are utilized.

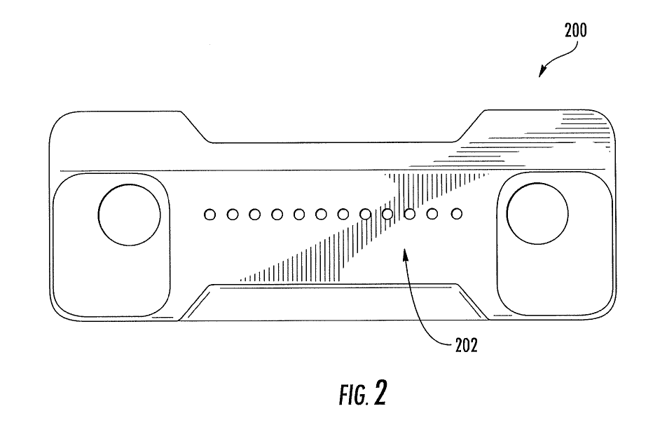

FIG. 2 depicts a multi-fiber optical connector 200, according to embodiments disclosed herein. As illustrated, the optical connector includes a plurality of input ports 202 that receive optical fibers in a predetermined array. The input ports 202 may be configured in a linear configuration, such that a conventional fiber optic ribbon is easily aligned and received at the optical connector 200. Additionally, while the optical connector 200 is illustrated as an MT connector with twelve (12) input ports 202, this is merely an example, as other types of connectors may be utilized for receiving any suitable number of optical fibers.

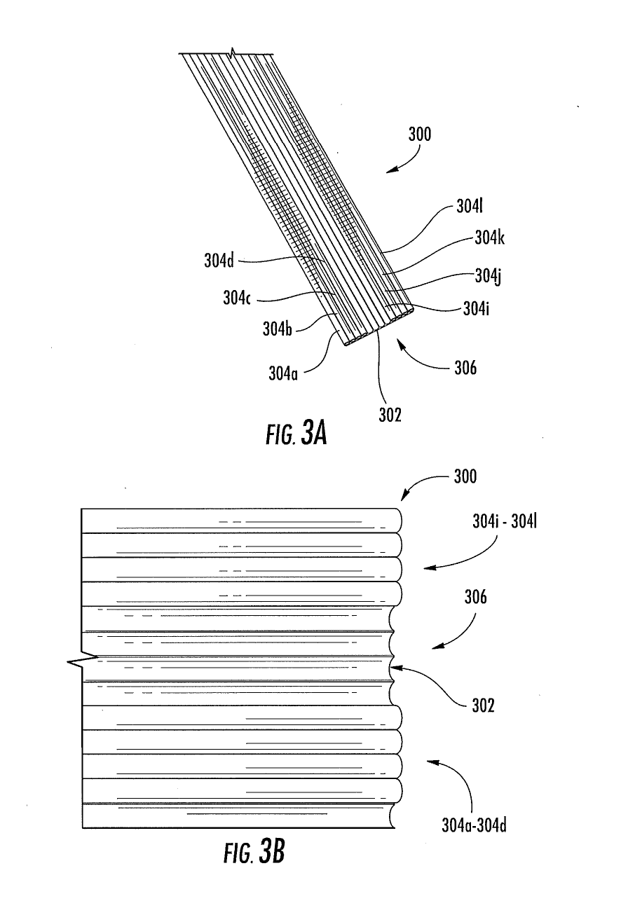

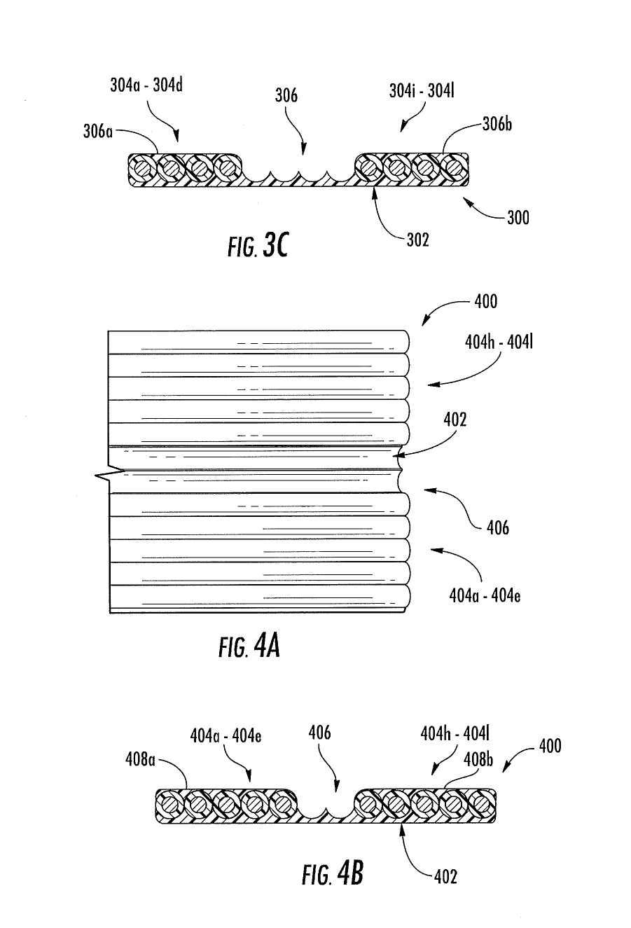

FIGS. 3A-3C depict a fiber assembly 300 having a tray region 306. As used herein, tray region means a location of the fiber assembly having fiber positions adjacent to non-transmitting optical fibers for receiving optical fibers that are intended for data transmission in a connector or the like. Fiber assembly 300 typically has a suitable length with a first number of fiber positions across its width (e.g., such as twelve fiber positions) in the fiber supporting matrix and includes a second number of secured optical fibers at predetermined fiber positions of the fiber supporting matrix (e.g., such as eight secured fibers that are non-transmitting fibers) and also includes the tray region 306. The second number of secured fibers in the fiber assembly 300 is less than the first number of fiber positions and provides empty fiber positions in the assembly for receiving fibers intended for data transmission. As shown, tray region 306 of the fiber supporing matrix has empty fiber positions for receiving and aligning longer lengths of optical fibers therein that are intended for data transmission in the connector, assembly or the like. In other words, the craft can use the empty fiber positions of the tray region 306 for aligning data transmitting optical fibers (i.e., a third number of installed fibers) relative to the secured fibers and then use the device for aligning the fibers with the desired optical fiber inputs of the connector, ferrule or the like such as a multifiber connector.

As best shown in FIG. 3C, tray region 306 of this embodiment includes four empty fiber positions in the assembly for receiving optical fibers that are not attached to the matrix material (i.e., the optical fibers intended for transmitting signals). As illustrated in FIG. 3A, the fiber assembly 300 is similar to the ribbon fiber 100 from FIG. 1, except that the second fiber supporting matrix side 102b, as well as the secured optical fibers 104e, 104f, 104g, and 104h have been removed to create the tray region 306. Stated another way, the fiber assembly may be created from a ribbon fiber 100 by stripping fibers out of the matrix material. Simply stated, the ribbon fiber can be cut to the desired length and then a portion of the fiber supporting matrix side is opened and/or removed so that the optical fibers such as the middle optical fibers can be peeled out of the assembly leaving empty fiber positions in the assembly as best shown in FIG. 3C. Accordingly, the fiber assembly 300 includes a fiber supporting matrix 302, as well as secured optical fibers 304a-304d and 304i-304l. Similarly, FIG. 3B depicts the fiber assembly 300 from an overhead view. As illustrated, the tray region 306 is formed from the fiber supporting matrix 302 that is devoid of the secured optical fibers in the fiber positions of 304e-304h. Thus, within the tray region 306 are the empty fiber positions, which are arranged in a linear manner across the width of the tray region 306 and extend the length of the tray region.

Fiber assembly disclosed herein are advantageous since they can be used for providing alignment of optical fibers into a connector where the connector has more fiber inputs than optical fibers intended for data transmission. By way of example, if the connector has twelve fiber inputs, but the connector will only have four optical fibers intended for data transmission the fiber assembly 300 aids in aligning the optical fibers into the desired inputs such as the center inputs of the connector or connector assembly. In other words, the fiber assemblies aid in aligning the optical fibers with the correct input ports of the connector, thereby providing quick and easy fiber to connector input port alignment during manufacture. Stated another way, the secured fibers of the fiber assembly are used for spacing and alignment for the optical fibers that are later inserted into the fiber assembly and intended for data transmission in the connector. Moreover, the fiber assemblies disclosed herein may be used as a relatively short assembly at the back end of a connector for alignment of the “transmitting” optical fibers or the fiber assemblies may be used in longer lengths for aligning optical fibers.

FIG. 3C depicts the fiber assembly 300 from a side view. As illustrated, the tray region 306 is formed in the area where no secured optical fibers 304 are connected to the fiber supporting matrix 302. Also illustrated in FIG. 3C is the profile shape of the fiber supporting matrix 302. More specifically, the fiber supporting matrix 302 includes a base side and a fiber supporting side that opposes the base side. The base side may be substantially flat; while the fiber supporting side may include the plurality of adjacent fiber positions, which in the profile view of FIG. 3C, appear to be partially arcuate or round in shape. However, the plurality of adjacent fiber positions may actually be shaped as a plurality of compartments such as partially cylindrical compartments or other suitable shapes. Similarly, on the opposing side, a fiber supporting matrix portion may be coupled to fiber assembly 300 across the secured optical fibers 304a-304d. Likewise, a fiber supporting matrix portion may be coupled to optical fibers 304i-304l.

It should be understood that while the fiber positions of the fiber supporting matrix 302 may be shaped as partially cylindrical compartments in FIGS. 3A-3C, the fiber positions may take any suitable shape for receiving an optical fiber. Additionally while in some embodiments, the fiber assembly 300 may be manufactured by removing and/or opening the second fiber supporting matrix side 102b (from FIG. 1) of the optical fiber ribbon and then peeling out the secured optical fibers 104e, 104f, 104g, and 104h (also from FIG. 1) from the middle of the optical fiber ribbon to form the fiber assembly, this is merely an example. In other embodiments, the fiber assembly 300 with the tray region 306 may be manufactured by leaving a predetermined number of fiber positions without a secured optical fiber; instead of peeling optical fibers out of a ribbon.

It should also be understood that while in FIGS. 3A-3C, a first portion of the secured optical fibers 304a-304d are positioned toward a first edge of the fiber supporting matrix and a second portion of the secured optical fibers 304i-304l are positioned toward a second edge, this is merely an example. Further, the empty fiber positions may be located on one or more outboard positions of the assembly; rather, than located in the middle of the assembly. More specifically, in some embodiments, the tray region 306 may be defined by any two adjacent empty fiber positions that are devoid of secured optical fibers 304.

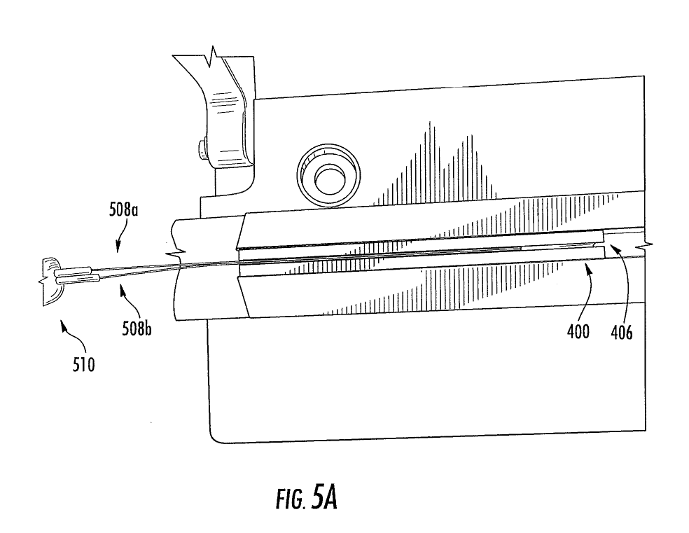

FIGS. 4A and 4B depict a fiber assembly 400 with a tray region that is created from two (2) empty fiber positions. Similar to the embodiment from FIG. 3A, in FIG. 4A, the fiber assembly 400 includes a fiber supporting matrix 402, a plurality of supported optical fibers 404a-404e and 404h-404l, as well as a tray region 406 that spans two empty fiber positions. Similarly, as also depicted in FIGS. 3A-3C, the empty fiber positions in the tray region 406 are configured to receive installed optical fibers that are intended for data transmission. Similarly, in FIG. 4B, the side view of the fiber assembly 400 illustrates the profile view of the tray region 406, which includes two adjacent empty fiber positions, as well as fiber supporting matrices portions on either side of the empty fiber positions for the respective secured optical fibers. In other words, the first fiber supporting matrix portion may be coupled to the supported optical fibers 404a-404e, while the second fiber supporting matrix portion is coupled to supported optical fibers 404h-404l.

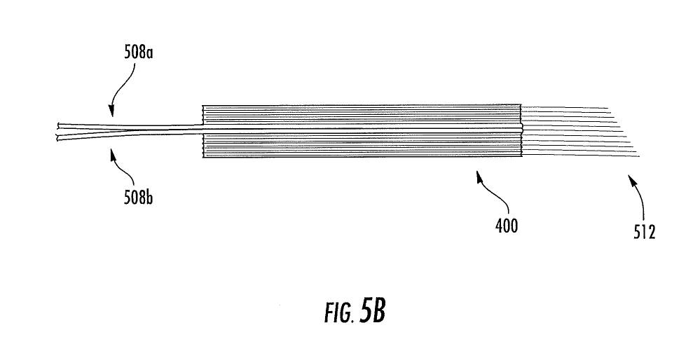

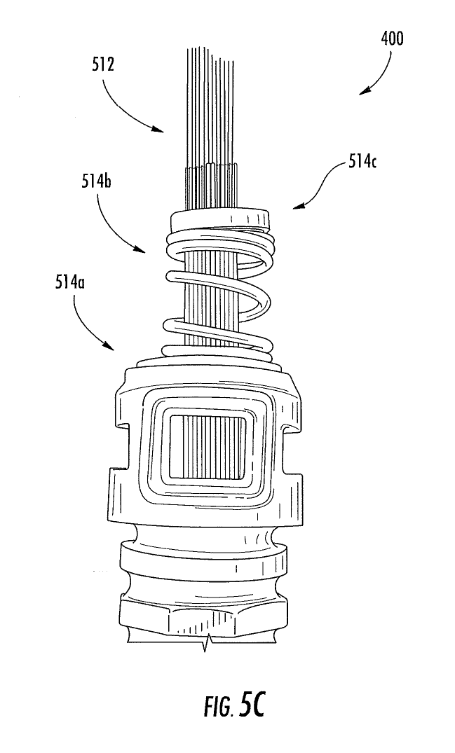

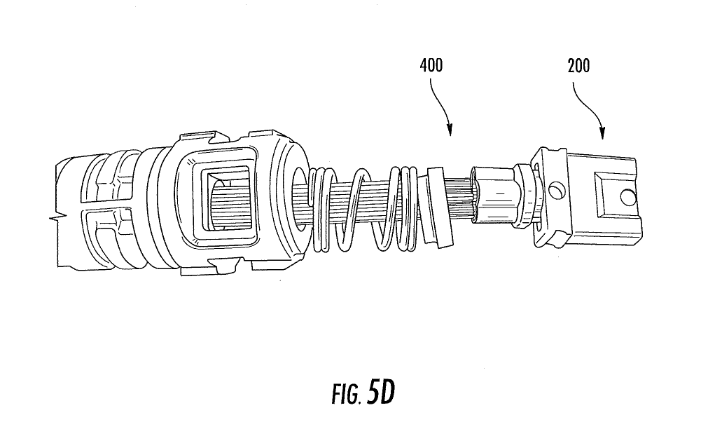

FIGS. 5A-5D depict steps for making an fiber assembly and then terminating a fiber optic connector using the fiber assembly. Specifically, FIGS. 5A and 5B show a fiber assembly 400 with a tray region 406, where the tray region 406 holds a plurality of installed fibers 508a and 508b of a fiber optic cable or the like disposed in the tray region. As illustrated by FIG. 4A, the fiber assembly 400 includes the fiber supporting matrix 402 that defines the tray region 406, as well as the supported optical fibers 404a-404e and 404h-404l. However, in the example of FIG. 5A, optical fibers from a source cable 510 (which includes installed fibers 508a and 508b) may be inserted into the tray region 406. The installed fibers 508a and 508b that are not secured in a linear or planar manner within the cable prior to being inserted into the tray region 406. Accordingly, once installed, the installed fibers 508a and 508b may be secured within the tray region 406 via an adhesive, such as a glue stick, adhesive lined tape (such as Kapton tape or other similar tape), and/or other adhesive. Using a glue stick or tape for aligning the ends of optical fibers in short lengths is well-known in the art.

FIG. 5B depicts an appropriate length of the fiber assembly 400, as well as the installed fibers 508a and 508b disposed in the tray region. As illustrated, the installed fibers 508a and 508b are inserted into the tray region 406 in the appropriate location/order and an end portion of the fiber assembly 400 has been stripped to a predetermined length for exposing the bare fibers 512 of both the supported fibers 404a-404e and 404h-404l and the installed fibers 508a and 508b. By inserting the installed fibers 508a and 508b into the empty fiber positions of the tray region 406, the installed fibers 508a and 508b are aligned in a planar fashion with the supported fibers for proper insertion into the fiber inputs of a connector. Thereafter, the assembly of FIG. 5B with the bare fibers 512 is easily inserted into the fiber inputs of a connector or other suitable device. Optionally, bare fibers 512 are cut at an angle as shown so that the bare fibers can be aligned and inserted into the fiber inputs of the desired device. In other words, the longest bare fiber can be aligned and inserted into the respective outboard fiber optic input of the desired device.

Next, suitable components may be threaded onto the assembly so the connector may be installed onto the assembly. By way of example, FIG. 5C depicts additional components that may be threaded onto the assembly for connecting the fiber assembly 400 to a connector such as an MT or OptiTip® connector available from Corning Cable Systems of Hickory, N.C. The plurality of connector components 514 threaded onto the assembly include a crimp body 514a, a spring 514b, and a spring centering cuff 514c. The plurality of components 514 provides a mechanism for connecting the fiber assembly 400 to the multi-fiber connector 200.

FIG. 5D depicts the fiber assembly 400 attached to the connector 200, thereby forming the connector assembly. As illustrated in FIG. 2, the multi-fiber connector 200 includes a plurality of optical inputs. Additionally, by inserting the installed fibers into the tray region, the installed fibers are properly aligned for insertion into the desired optical inputs of the connector 200 for the channels intended for data transmission. Simply stated, the fiber assembly 400 is coupled with the connector 200 such that the installed fibers are inserted into the desired input ports 202 (see FIG. 2) and the secured optical fibers are inserted into the desired input ports 202; however, only the inserted optical fibers are intended for data transmission and supported optical fibers are not connected rearward of the connector. By inserting all of the optical fibers of the completed fiber assembly into the corresponding inputs ports 202, the installed fibers are properly aligned for data transmission and inserting the optical fibers into the wrong input ports of the device is avoided.

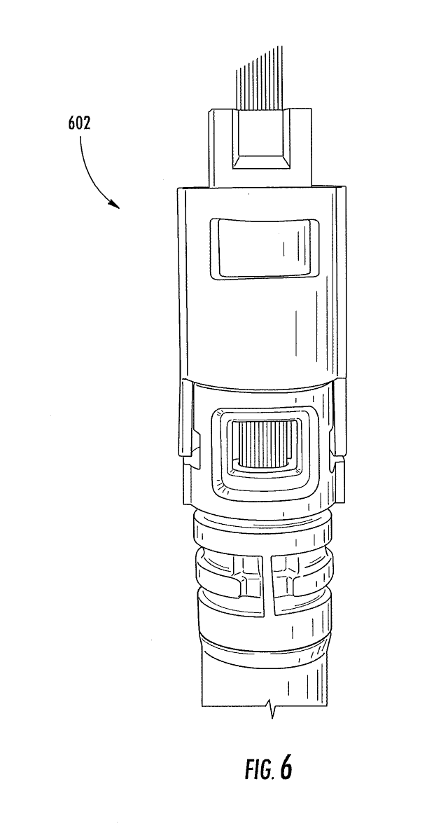

FIG. 6 depicts a fiber assembly 300 and/or 400 with a tray region 306 and/or 406 that holds a plurality of installed fibers 508a-508d, where the installed fibers 512 are input into a connector 200. As illustrated, an inner housing 602 is orientated and snapped into position seating the ribbon tray assembly inside the multi-fiber connector 200 with the correct fiber orientation. Thereafter, any other processing and/or manufacturing steps such as polishing the end face of the connector may occur.

It should be understood that while FIGS. 4A, 4B, and 5A-5D depict an embodiment that utilizes two installed fibers in the tray region, this is merely an example. As illustrated in FIGS. 3A-3C, embodiments where 4 (or other number) installed fibers may be utilized. According to the concepts of the disclosure, fiber assemblies can have any suitable number of fiber positions, empty positions and/or installed fibers.

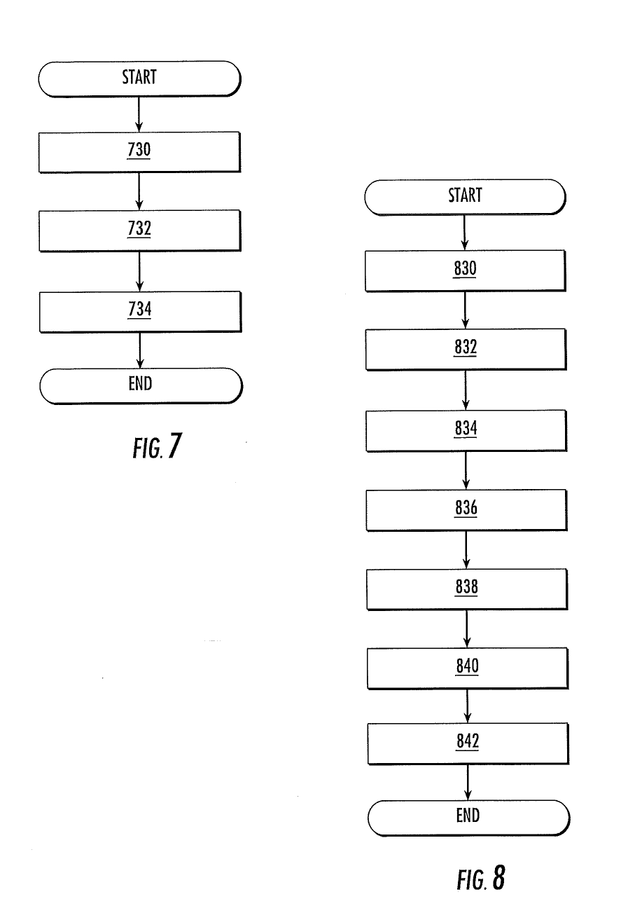

FIG. 7 depicts a process flowchart for manufacturing a fiber assembly with a tray region, according to concepts disclosed herein. As illustrated, the process may be utilized for a fiber assembly 400 with a tray region 406 from a ribbon fiber 100, the ribbon fiber 100 including a first fiber supporting matrix 102a that includes a base side and a fiber supporting side that opposes the base side. The first fiber supporting matrix 102a may have a length and a width, where the fiber supporting side includes a first number of empty fiber positions that are shaped as compartments such as partial cylindrical compartments and assembled in a linear configuration across the width. Additionally, the empty fiber positions may extend along the length of the first fiber supporting matrix 102a, where the ribbon fiber 100 includes a corresponding number of secured optical fibers 104 that are secured in the empty fiber positions. In this context, at block 730, a first portion of the secured fibers may be removed from the fiber assembly to create a tray region 306. At block 732, installed fibers 508 are placed into the tray region 406, each of the installed fibers 508 being positioned within a corresponding compartment. At block 734 an adhesive or the like may be applied to the installed fibers 508 for holding the same in the assembly.

FIG. 8 depicts a process flowchart for manufacturing a fiber assembly with a tray region and connector components, according to concepts disclosed herein. Block 830 represents a fiber optic cable that includes one or more optical fibers by prepared to a predetermined strip length as known in the art. At block 832, one or more fibers may be removed from an optical fiber ribbon as desired by peeling the optical fibers from the ribbon to form the tray region of the fiber assembly, and optionally the fiber assembly may be cut to the desired length. At block 834, the desired optical fibers of the fiber optic cable are installed into the tray region of the fiber assembly. Optionally, a fixture may be used to aid the craft in installing the optical fibers into the fiber assembly. At block 836, an adhesive may be applied over the installed and secured fibers for holding the installed optical fibers within the fiber assembly. At block 838, the installed and secured optical fibers of the fiber assembly may be stripped over a predetermined length to bare fiber. At block 840, connector components may be threaded onto the fiber assembly. At block 842, component of the connector may be installed such as orientating and snapping an inner housing into position by seating the tray assembly inside the fiber inputs connector with correct fiber orientation.

It should be understood that while a specific connector is disclosed in embodiments above, these are merely examples and the fiber assembly may be used with other assemblies. Other applications could include enclosures, where the applicable section extends from the ferrule in the connector to a point beyond the connector, and up to an epoxy plug to protect the individual fibers in a more robust structure. In these embodiments, the bond is substantially permanent in order to avoid additional mechanical features than the existing routing mechanism. Similarly, as discussed above, some embodiments may utilize ruggedized connectors such as the OptiTip®, where the tray feature becomes part of the ferrule assembly in order to guide individual fibers into position. Still some embodiments utilize a mechanical splice, where fibers are mechanically coupled via two multifiber ferrules (e.g., MT ferrules or variants thereof). The fibers may reside inside an enclosure and the tray region adds durability to the individual fibers. Still other embodiments utilize a fusion splice, where fibers are fused together for optical connectivity and ultimately packaged in a splice protector housing. The added fiber tray section would reach from the splice protector to any end structure like a furcation or a connector as in section.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A fiber assembly, comprising:
a fiber supporting matrix that comprises a fiber supporting side, the fiber supporting matrix having a length and a width, wherein the fiber supporting side comprises a first number of fiber positions that are assembled in a configuration across the width and extend along the length from a first end to a second end of the fiber supporting matrix;
a second number of secured non-transmitting fibers that are secured in a second number of corresponding fiber positions, wherein the second number of secured non-transmitting fibers terminate approximately at the first end of the fiber supporting matrix;
a tray region on the fiber supporting matrix that is defined by a corresponding number of empty fiber positions that do not secure the second number of secured non-transmitting fibers; and
a third number of installed active fibers, wherein the third number of installed active fibers are installed into the empty fiber positions, and wherein the third number of installed active fibers extend beyond the first end and the second end of the fiber supporting matrix.

2. The fiber assembly of claim 1, wherein a first portion of the secured non-transmitting fibers are secured at a first subset of the first number of fiber positions and a second portion of the secured non-transmitting fibers are secured at a second subset of the first number of fiber positions and wherein the tray region is defined by the empty fiber positions that are between the first portion of the secured non-transmitting fibers and the second portion of the secured non-transmitting fibers.

3. The fiber assembly of claim 1, wherein the secured non-transmitting fibers extend beyond the second end.

4. The fiber assembly of claim 1, wherein the third number of installed active fibers is one of the following: 2 fibers and 4 fibers.

5. The fiber assembly of claim 1, wherein the third number of installed active fibers are coupled to a multi-fiber connector.

6. The fiber assembly of claim 1, further comprising a multi-fiber optical connector that receives the installed active fibers and the secured non-transmitting fibers.

7. The fiber assembly of claim 1, further comprising a crimp body, a spring, and a spring centering cuff

8. A fiber assembly, comprising:
a fiber supporting matrix that comprises a length and a width, wherein the fiber supporting matrix comprises a first number of fiber positions that are assembled in a linear configuration across the width and extend along the length from a first end to a second end of the fiber supporting matrix;
a second number of secured non-transmitting fibers that are secured in a portion of the first number of fiber positions, wherein the second number of secured non-transmitting fibers terminate approximately at the second end of the fiber supporting matrix; and
a tray region on the fiber supporting matrix that is defined by a plurality of adjacent empty fiber positions that do not secure the second number of secured non-transmitting fibers, wherein the tray region receives a third number of installed active fibers that correspond to the plurality of adjacent empty fiber positions.

9. The fiber assembly of claim 8, wherein a first portion of the secured non-transmitting fibers are secured at a first subset of the first number of fiber positions and a second portion of the secured non-transmitting fibers are secured at a second subset of the first number of fiber positions and wherein the tray region is defined by the plurality of adjacent empty fiber positions that are between the first portion of the secured non-transmitting fibers and the second portion of the secured non-transmitting fibers.

10. The fiber assembly of claim 8, wherein the secured non-transmitting fibers extend beyond the second end.

11. The fiber assembly of claim 8, wherein the third number of installed active fibers is one of the following: 2 fibers and 4 fibers.

12. The fiber assembly of claim 8, further comprising a multi-fiber optical connector that receives the installed active fibers and the secured non-transmitting fibers.

13. The fiber assembly of claim 8, further comprising a crimp body, a spring, and a spring centering cuff.

14. A fiber assembly, comprising:
a fiber supporting matrix that comprises a fiber supporting side, wherein the fiber supporting side comprises a first number of fiber positions that extend across a width of the fiber supporting matrix and extend along a length of the fiber supporting matrix from a first end to a second end of the fiber supporting matrix;
a second number of secured non-transmitting fibers that are secured in a corresponding number of fiber positions, wherein the second number of secured non-transmitting fibers are not secured to a source and terminate approximately at the second end of the fiber supporting matrix; and
a tray region on the fiber supporting matrix that is defined by empty fiber positions that do not secure the second number of secured non-transmitting fibers, wherein the tray region receives a third number of installed active fibers from a source that transmits a signal, wherein the third number of installed active fibers corresponds to the empty fiber positions.

15. The fiber assembly of claim 14, wherein a first portion of the secured non-transmitting fibers are secured at a first subset of the first number of fiber positions and a second portion of the secured non-transmitting fibers are secured at a second subset of the first number of fiber positions and wherein the tray region is defined by the empty fiber positions that are between the first portion of the secured non-transmitting fibers and the second portion of the secured non-transmitting fibers.

16. The fiber assembly of claim 14, wherein the third number of installed active fibers are coupled to a multi-fiber connector.

17. The fiber assembly of claim 14, further comprising a crimp body, a spring, and a spring centering cuff

18. The fiber assembly of claim 14, wherein the third number of installed active fibers is one of the following: 2 fibers and 4 fibers.

19. The fiber assembly of claim 14, further comprising a multi-fiber optical connector that receives the installed active fibers and the secured non-transmitting fibers.

20. The fiber assembly of claim 14, wherein the secured non-transmitting fibers extend beyond the second end.
